(19) United States
(12) Patent Application Publication
(10) Pub. No.: US 2009/0139891 A1
(43) Pub. Date: Jun. 4, 2009

(54) LAYERED SHRINK FILM, METHOD FOR PRODUCING LAYERED SHRINK FILM, AND CONTAINER USING LAYERED SHRINK FILM

(75) Inventors: Kenji Oshima, Fukuoka (JP); Shigeyuki Takao, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/295,136

(22) PCT Filed: Feb. 29, 2008
(86) PCT No.: PCT/JP2008/000412

§ 371 Date: Sep. 29, 2008

(30) Foreign Application Priority Data
Mar. 1, 2007 (JP) 2007-050976

(51) Int. Cl. B65D 65/22; B41M 5/41; B32B 38/14

(52) U.S. Cl. 206/497; 428/32.22; 156/277

(57) ABSTRACT

It is an object to provide a layered shrink film capable of conducing fine ink printing using a water-based ink and having excellent fastness properties, a method for producing the same, a container fitted with the layered shrink film, and a method for producing the container. After forming a hydrophilic ink absorbing layer (2) on one surface of a film substrate (1) having heat shrinkability and conducting printing by a water-based ink-jet method, a thermoplastic resin layer (4) capable of shrinking in association with heat shrinkage of the film substrate and having water resistance and scratch fastness is formed on the print side of the film substrate.

### TECHNICAL FIELD

The present invention relates to a film print using a heat-shrink film as a substrate, that is used in labels of bottles and containers of drinks, foods, condiments, cosmetics and the like, and in packaging. More particularly, it relates to a layered shrink film on which printing has been applied by a water-based ink, a method for producing the layered shrink film, a containing fitted with the layered shrink film, and a method for producing the container.

### BACKGROUND ART

Recently, film prints using a heat-shrink film (shrink film) as a substrate are widely used as labels and wrapping films, to be attached to bottles and containers constituted of, for example, a resin or a glass, that are used in commercial products of drinks, foods, condiments, cosmetics and the like.

For example, Patent Document 1 discloses that such a film print uses as a heat-shrink film substrate, a stretched film having a thickness of from about 20 to 80 micro meters using a polystyrene resin such as a styrene-butadiene copolymer, a polyester resin such as a polyethylene terephthalate (PET), a polyolefin resin such as a polypropylene, and a thermoplastic resin such as a vinyl chloride resin, as a raw material, and an image is printed on the surface of a heat-shrink film by plate printing such gravure printing, flexo printing, offset printing or the like using mainly an oil-based ink.

Such a method using a plate printing is suitable to the case of mass-producing prints having the same design. However, plate-making is required, and in the case of producing prints in small quantities, productivity is rather poor in the points of costs and the delivery date. Particularly, in the past several years, response to small rot production is demanded even in the above-described fields of labels and wrapping films due to a wide variety of products in small quantities, and diversification of design. For example, practical application of high-grade on-demand printing and plateless printing by a water-based ink, represented by an ink-jet printing method is desired.

However, an ink-jet printing ink contains a binder component such as a resin in small amount, differing from a plate printing ink, has low viscosity and poor quick-dry properties, and is based on the promise of image formation to a printing medium having liquid absorbability by permeation drying. Therefore, it is difficult to form and fix a high-definition image on the surface of a heat-shrink film that has not ink absorbability. From such a background, plateless printing of a heat-shrink film using an ink-jet printing method is investigated by the following technologies.

For example, Patent Document 2 discloses the technology that ink-jet printing is conducted on a heat-shrink film using a radiation-curing ink containing a coloring material, a radical-polymerizable compound, a polymerization initiator and the like, and the ink is then cured by irradiation with radiation such as ultraviolet ray.

Patent Document 3 discloses the technology that ink-jet printing is conducted on a heat-shrink film using an electron beam-curing ink containing a coloring material, a electron beam-polymerizable monomer and the like, and the ink is then cured by irradiation with electron beam.

Patent Document 4 and Patent Document 5 disclose the technology that an ink absorbing layer capable of absorbing a water-based ink-jet ink and having hydrophilicity and water solubility is formed on one side of a heat-shrink film, making it possible to conduct water-based ink-jet printing.

### Patent Citation 1: JP-A-2004-238578

### Patent Citation 2: JP-A-2003-285540

### Patent Citation 3: JP-A-2004-042466

### Patent Citation 4: JP-A-2001-293954

### Patent Citation 5: JP-A-2006-178352

### DISCLOSURE OF INVENTION

### Technical Problem

However, where a radiation-curing ink is used as in Patent Document 2, a special ink comprising a polymerizable compound as the main component is necessary. Therefore, as compared with the general water-based ink-jet ink, freedom of ink design is narrow, and because of high viscosity, load to liquid discharge performance of an ink-jet head is increased, and as a result, it is difficult to form a high-definition image. Furthermore, it is necessary for an ink to be irradiated with radiation having relatively high energy in order to sufficiently cure the ink. As a result, there is the possibility that a printed side excessively produces heat, and problems of shrinkage of a heat-shrink film and generation of wrinkle are liable to occur.

Where a radiation-curing ink is used as in Patent Document 3, problems of shrinkage of a heat-shrink film due to generation of heat on the printed side and generation of wrinkle are difficult to occur. However, the same problems as in the case of using the radiation-curing ink as described before are caused in the points.

Where water-based ink-jet printing is conducted by forming an ink absorbing layer on one side of a heat-shrink film as in Patent Document 4 and Patent Document 5, the above-described problems are not caused. It is possible to improve water resistance of an absorbing layer to a certain extent by the addition of a crosslinking agent or the like. However, an ink absorbing layer comprising a hydrophilic resin as the main component and the printed side are not protected. Therefore, fastness properties durable to use as labels and packaging films that are assumed to receive water wetting, high humidity environmental shelf, and external actions such as rubbing or bending, for example, water resistance, scratch fastness and environmental shelf reliability, are not obtained. Thus, practical utility is poor. Furthermore, in this case, where it is attempted to improve water resistance by adding a crosslinking agent or the like, water absorbability of the absorbing layer deteriorates. As a result, there is the problem that it is difficult to absorb and fix a sufficient amount of an ink-jet ink, making it difficult to obtain a high definition image.

The present invention has an object to provide a layered heat-shrink film capable of conducing fine ink printing using a water-based ink, particularly ink-jet printing, and having excellent fastness properties, a method for producing the same, a container fitted with the layered heat-shrink film, and a method for producing the container.

### Technical Solution

The present invention has been made in view of the above problems, and relates to a layered heat-shrink film comprising a substrate having heat shrinkability, an ink absorbing layer, and a protective layer which shrinks in association with heat shrinkage of the substrate, the ink absorbing layer being interposed between the substrate and the protective layer.

### ADVANTAGEOUS EFFECTS

According to the present invention, fine plateless printing by a water-based ink, particularly by an ink-jet method using a water-based ink, is possible, and a layered heat-shrink film having excellent fastness properties can be realized. Furthermore, it is possible to prevent deterioration of the printed side due to water stained, leaving to stand in high humidity environment, and action by external force such as rubbing or bending. In other words, excellent water resistance and scratch fastness can be imparted to the printed side.

### BRIEF DESCRIPTION OF THE DRAWINGS

FIG. 1 is a cross sectional view schematically showing a cross section of the layered heat-shrink film according to the embodiment of the present invention.

FIG. 2 is a flow chart of the representative method for producing the layered heat-shrink film according to the embodiment of the present invention.

FIG. 3 is a cross sectional view schematically showing a cross section of the layered heat-shrink film in each stage of the representative method for producing the layered heat-shrink film according to the embodiment of the present invention.

FIG. 4 is a cross sectional view schematically showing a cross section of the layered heat-shrink film according to the embodiment of the present invention in the case that an underlying layer is formed.

### BEST MODE FOR CARRYING OUT THE INVENTION

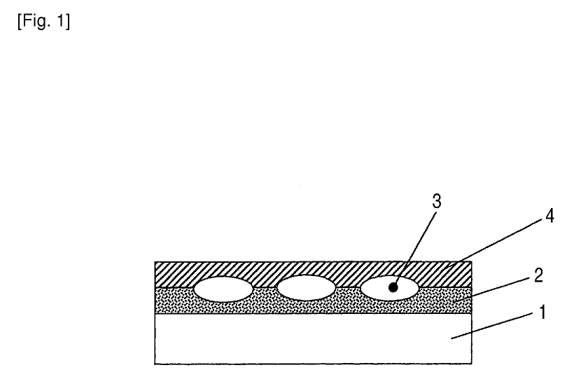

Each embodiment of the present invention is described below using FIGS. 1 to 4.

In the embodiment of the present invention, particularly constitution and materials of a layered heat-shrink film are described in detail below.

FIG. 1 is a cross sectional view schematically showing a cross section of the layered heat-shrink film according to the embodiment of the present invention.

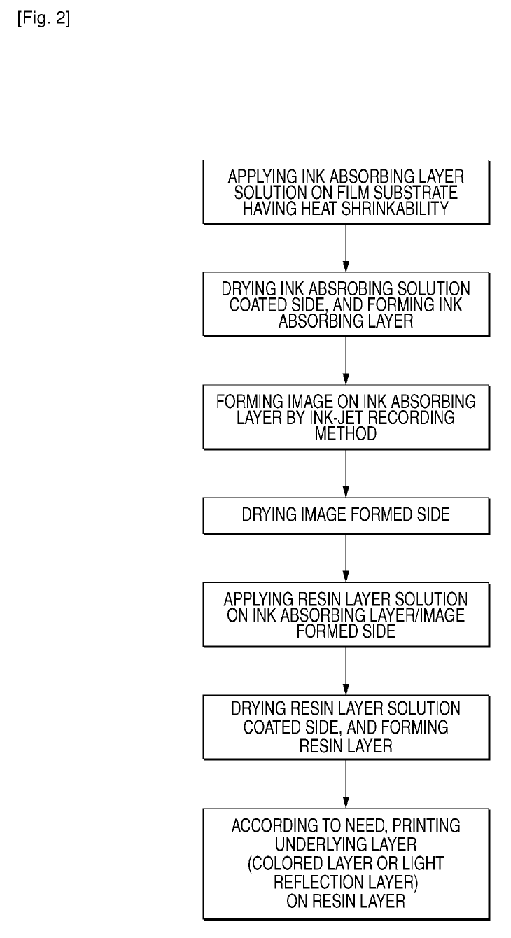

FIG. 2 is a flow chart of the representative method for producing the layered heat-shrink film according to the embodiment of the present invention.

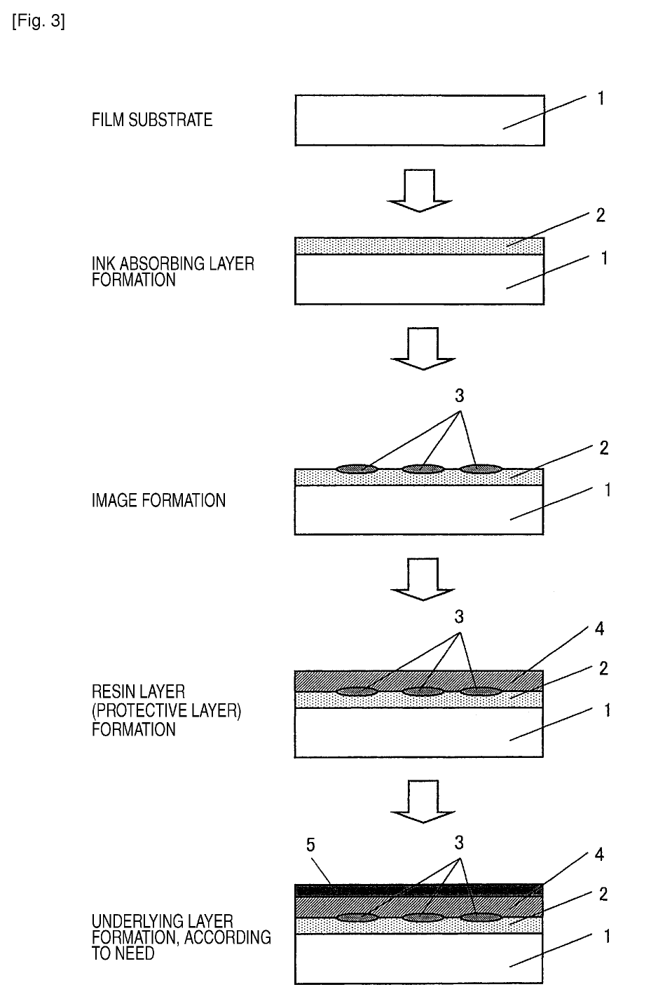

FIG. 3 is a cross sectional view schematically showing a cross section of the layered heat-shrink film in each stage of the production method as in FIG. 2.

The layered heat-shrink film according to the embodiment of the present invention is characterized in that a hydrophilic ink absorbing layer 2 is formed on one side of a substrate 1 having heat shrinkability (hereinafter referred to as “film substrate 1”), a printing image using a water-based pigment ink 3 (hereinafter referred to as “ink 3”) is formed on the hydrophilic ink absorbing layer 2 by an ink-jet method, and a protective layer capable of shrinking in association with heat shrinkage of the film substrate 1 and constituted of a thermoplastic resin having water resistance and scratch fastness (hereinafter referred to as “resin layer 4”) is formed on the printing image.

This constitution makes it possible to realize a layered heat-shrink film capable of conducting a fine plateless printing and having excellent fastness properties.

When the layered film is generally used to a label for container, it is desired that the film substrate 1 has shrinkage of about 30% or more, considering handling in production steps and the like, securing of performance as a label, and the like.

Examples of the heat-shrink film substrate 1 that can be used in the present invention include heat-shrink stretched plastic films using polystyrene resins such as a styrene-butadiene copolymer, polyester resins such as a polyethylene terephthalate (PET), polyolefin resins such as a polypropylene, and thermoplastic resins such as a vinyl chloride resin, as a raw material.

Above all, a polyester stretched film has excellent chemical resistance. Therefore, the film substrate 1 is difficult to be attacked by an organic solvent as a solvent of a thermoplastic resin solution in the application step of the thermoplastic resin solution. As a result, damage to the film substrate 1 can be prevented, and additionally, the choice of the organic solvent and the thermoplastic resin is spread, thereby the resin layer 4 having further high performance can be designed.

It is preferred that the film substrate 1 has a film thickness of from about 30 to 60 micro meters mm and a degree of shrinkage of about 30% or more at 90 degree in a main stretching direction in order to secure handling properties in film formation of each layer and printing step, and performance as a layered heat-shrink film.

Examples of the commercially available products of the heat-shrink film substrate 1 that can preferably be used in the present invention include DXL film (trade name), HISHIPET (trade name) and HISHILEX (trade name), products of Mitsubishi Plastics, Inc.), and FANCYWRAP (trade name), a product of Gunze Limited).

In using the film substrate 1 to the present invention, surface treatment such as corona discharge may be applied to the film substrate 1 for the purpose of improving wettability and adhesion to the film substrate 1 in molding the ink absorbing layer 2.

The ink absorbing layer 2 preferred in the present invention is a swelling type, and comprises a water absorption polymer mainly comprising a partially benzalated polyvinyl alcohol and a dicyandiamide type cationic resin. The content of the dicyandiamide type cationic resin is preferably from about 10 to 30% in weight ratio to the content of the partially benzalated polyvinyl alcohol from the standpoint of promoting the balance between ink absorbability and water resistance.

Where the content is less than 10%, liquid absorption properties of the ink absorbing layer 2 are decreased. As a result, the ink 3 bleeds on the surface of the absorbing layer or droplets of the ink 3 gather to form fish-eye, making it easy to cause uneven concentration and bleeding. As a result, a high-definition image cannot be obtained in the image formation stage. On the other hand, where the content exceeds 30%, water absorbability of the ink absorbing layer 2 becomes too high, and dot diameter is smaller than the desired value in the image formation stage, and cord is liable to be generated in an image. Additionally, deterioration of water resistance becomes the problem. For example, where the ink absorbing layer 2 is contacted with water over a long period of time, the ink absorbing layer 2 swells, and adhesion to the film substrate 1 deteriorates. As a result, wrinkle may be generated in the layered film, and in the severe case, the layered film may delaminate.

The ink absorbing layer 2 can contain a spherical resin powder, a polyether-modified silicone and the like as additives, thereby improving blocking resistance and realizing high dot circularity. As a result, a high-definition image molding can be obtained as a rolled film having high productivity.

The ink absorbing layer 2 may further contain other polymers other than the partially benzalated polyvinyl alcohol. Examples of the other polymer include natural resins such as albumin, gelatin, casein, starch, cationated starch and gum Arabic; cellulose derivatives such as methyl cellulose and hydroxymethyl cellulose; and synthetic resins such as polyvinyl alcohol, cation-modified polyvinyl alcohol, anion-modified polyvinyl alcohol, polyamide resin, polyacrylamide, quaternized polyvinyl pyrrolidone, polyethylene imine, polyvinyl pyridilium halide, polyurethane, polyester and sodium polyacrylate. Those can be used alone or as mixtures of two or more thereof.

The ink absorbing layer 2 may further comprise the following resin in order to improve strength of the ink absorbing layer 2 and adhesion to a substrate. Examples of the resin include SBR latex, NBR latex, polyvinyl formal, polymethyl methacrylate, polyvinyl butyral, polyacrylonitrile, polyvinyl chloride, polyvinyl acetate, phenolic resin and alkyd resin.

A method for forming the ink absorbing layer 2 preferred in the present invention is that a composition containing the above-described resins is uniformly applied to the film substrate 1, dried and film-formed. More specifically, the ink absorbing layer 2 can be produced as follows. The above-described resins and according to need, other components are dissolved or dispersed in an appropriate solvent to prepare a coating liquid. The coating liquid is applied to the film substrate 1 by a method using a roll coater, a bar coater, spray coater, air-knife coater, a gravure coater, a reverse coater, a pipe coater, a comma coater or the like, and then dried.

The ink absorbing layer 2 preferred in the present invention has a film thickness of preferably from about 2 to 30 micro meters, and more preferably from about 5 to 15 micro meters. Where the film thickness of the ink absorbing layer 2 is less than 2 micro meters, absorption volume of the ink 3 is deficient, the droplets of ink 3 gather on the surface of the absorbing layer to form fish-eye, and uneven concentration and bleeding are liable to be caused. As a result, image deterioration and uneven printing are liable to induce. On the other hand, where the film thickness exceeds 30 micro meters, a film is greatly curled after application and drying, and this brings about the problem at the time of image formation. Additionally, a degree of shrinkage of the film substrate 1 is impaired when heat shrinking, or where adhesion to the film substrate 1 is low, the absorbing layer film may peel from the film substrate 1 or wrinkles may be generated. Furthermore, unnecessary increase in const is invited.

The image formation method preferred in the present invention is preferably conducted by a printing method comprising steps of discharging the ink 3 having high affinity with the ink absorbing layer 2 and high absorption rate by an ink-jet recording method to form an image, heating at least the image formation area, and drying.

The ink-jet recording method may be a continuous method in which the ink 3 is continuously discharged in a constant interval, and of droplets of the ink 3 discharged, only droplets necessary for image formation are deflected and selected to form an image, and may be an on-demand method in which the ink 3 is discharged in response to image data. The on-demand method is preferred from the points that it is possible to control fine implantation, the amount of a waste liquid is small, use efficiency of the ink 3 is high, and the like. The ink discharging method includes a method of discharging the ink 3 using an electromechanical converter such as a piezoelectric element, and a method of discharging the ink 3 by heating the same with an electromechanical converter such as a heater element having a heating resistor, but is not particularly limited.

The drying treatment includes a method of printing to a plate or a drum, heated to a heat shrinkage temperature or lower and contacting the back of a film, and a method of spraying hot air onto a printed side. However, the drying treatment is not particularly limited so long as it is a method of rising a temperature of water and volatile components in the ink 3 and accelerating evaporation.

The ink 3 preferably used in the present invention generally comprises a coloring material, a moisturizer, a resin additive and water. In general, for permeation adjustment, viscosity adjustment, surface tension adjustment, pH adjustment and the like, a composition further containing various solvent components, surfactants, additives and the like, wherein the coloring material is a pigment and liquid is aqueous, is preferred. The coloring material can use a water-soluble dye, a disperse dye, and a non-water-soluble dye (in the case of kneading and adding with a resin emulsion). Liquid coloring materials and oil coloring materials can be used.

Regarding the kind of the ink 3, generally where color recording is conducted, process colors of black, cyan, magenta, yellow and subtractive color mixture, and according to need, each color ink of black, orange, green or the like, and a so-called light ink such as light cyan, light magenta, photoblack (middle black, light black or the like) and the like, can be used. The combination of the ink 3 is not particularly limited, and those inks can optionally be combined. The combination includes the above-described four primary colors, six colors comprising the four primary colors and two colors of light cyan and light magenta or two colors of orange and green, added thereto, and five to eight colors comprising those three to six colors, and middle black and light black added thereto. Any ink can be used so long as it has good affinity with water as the main solvent, or can uniformly be dispersed by the co-use of a dispersing agent or the like.

A resin material used for the formation of the thermoplastic resin layer 4 (protective layer) of the present invention should use a thermoplastic resin that can be liquefied using an organic solvent as a solvent, has adhesiveness to the ink absorbing layer 2 and can form a flexible coating film having strength, water resistance and moisture resistance durable to the use as labels and outer coverings.

When a thermoplastic resin having a heating temperature in the case of heat shrinking the layered film of the present invention, that is, a glass transition temperature lower than a heat shrinkage temperature of the film substrate 1, is used, the thermoplastic resin has a temperature higher than a glass transition temperature at the heat shrinkage temperature of the film substrate, and is in a state that micro-Brownian motion of molecules is opened. As a result, excellent follow-up properties to heat shrinkage of the film substrate can be secured, and a layered heat-shrink film having high shrink properties can be realized without causing wrinkles or peeling in the resin layer 4.

It is preferred to use a material having excellent water resistance and moisture resistance. Furthermore, it is necessary to hold appearance and quality as labels and outer coverings, and additionally, to have chemical resistance to an alkali, an alcohol, a detergent and the like, considering adaptability to mechanical apparatuses in production process.

From the above standpoints, examples of the preferred resin material include a vinylidene chloride copolymer, a vinyl chloride-vinyl acetate copolymer, an acryl-vinyl acetate copolymer, a styrene-butadiene-hydrocarbon copolymer, a modified polypropylene polymer and a polystyrene-polybutadiene copolymer.

Above all, the vinylidene chloride copolymer and vinyl chloride-vinyl acetate copolymer can form the resin layer 4 having very high water resistance, moisture resistance and strength, and therefore can realize a layered heat-shrink film having particularly excellent fastness properties.

The vinylidene chloride copolymer is preferably a copolymer having a compositional ratio of vinylidene chloride of about 80% or more, and particularly excellent fastness properties are obtained. Additionally, a polymer having high crystallinity is particularly preferred.

The vinyl chloride-vinyl acetate copolymer that is preferably used is a copolymer having a compositional ratio of vinyl chloride of about 80% or more, and particularly excellent fastness properties are obtained.

Heat shrinkage treatment of the heat-shrink film generally uses steam or hot air. Therefore, it is preferred that the glass transition temperature of the resin is 90 degree or lower.

A method for forming the resin layer 4 is described below.

The resin layer 4 can be formed by applying a solution of the above-described thermoplastic resin dissolved in an organic solvent to a printing side, and evaporating the organic solvent at a temperature lower than the temperature at which the film substrate 1 initiates to shrink, a temperature of about 60 degree or lower.

The organic solvent can use a solvent that can dissolve a resin used in the resin layer 4 and has volatility to an extent that the solvent can evaporate under the above-described temperature conditions. From this standpoint, various organic solvents used as a low boiling solvent or a medium boiling solvent for paint can generally be used.

Examples of the organic solvent include ketone solvents such as acetone, methyl ethyl ketone and cyclohexanone; ester solvents such as ethyl acetate and butyl acetate; aromatic hydrocarbon solvents such as toluene and xylene; and tetrahydrofuran. When those are mixed and used, it is possible to adjust volatility, swelling, dissolution, wetting, permeability and the like.

It has been found that when a material having properties capable of swelling the ink absorbing layer 2 is used as an organic solvent, a heat-shrink film having further high water resistance can be realized even in the case of using the same resin. Regarding this point, of the above-described organic solvents, it is preferred to blend a solvent having relatively high dissolving powder such as methyl ethyl ketone, ethyl acetate, toluene, xylene and tetrahydrofuran.

The term (swelling) used herein means a phenomenon that the ink absorbing layer 2 swells by absorbing an organic solvent. In this case, the thermoplastic resin dissolved in the organic solvent can be introduced into the ink absorbing layer together with the organic solvent. This markedly improves adhesion between the ink absorbing layer 2 and the resin layer 4, thereby overcoming the problems such as peeling.

Thus, when the ink absorbing layer is impregnated with the thermoplastic resin, even in the case that the layered heat-shrink film of the present invention is cut at any portion, under normal circumstances the cut cross section is that the ink absorbing layer is directly exposed, and water is absorbed from the portion, thereby the layered heat-shrink film deteriorates. However, because the ink absorbing layer is impregnated with the thermoplastic resin, the ink absorbing layer is not exposed in its form at the cut portion, and the proportion of absorbing water is small. As a result, the degree of deterioration is small as the layered heat-shrink film.

The resin and organic solvent described above are stirred and mixed by the various conventional methods to dissolve the resin in the organic solvent, thereby preparing a coating resin solution. The resin solution is applied to an absorbing layer having been subjected to ink-jet printing, by various conventional methods, and the organic solvent is evaporated at a temperature lower than the temperature at which the film substrate 1 initiates to shrink, a temperature of about 60 degree or lower. Thus, the resin layer 4 as a protective layer can be formed. Drying of the organic solvent can use a hot air heater and a drying oven.

In the step of evaporating the organic solvent, a slight amount of the organic solvent remains in the protective layer. However, the performance as the protective layer is not impaired by a slight amount of the residual organic solvent.

Concentration of the resin in the resin solution is adjusted in a range of from about 10 to 50% in weight ratio, in conformity with viscosity of the solution and the coating conditions.

The resin layer 4 after drying has a film thickness in a range of preferably from 5 to 30 micro meters, and more preferably from 10 to 20 micro meters. Where the film thickness is smaller than 5 micro meters, it is difficult to obtain sufficient fastness properties. Where the film thickness is larger than 30 micro meters, it induces unnecessary increase in cost due to the increase of material cost, relative to the required performance, and there is the possibility of causing deterioration of handling properties as a layered film and shrinkage follow-up properties.

Water resistance, moisture resistance and strength of the resin layer 4 formed are largely determined by the performance of the resin used. Where the heat-shrink film is used as a label or an outer covering of a container as a commercial product, it is necessary to prevent damage by rubbing or scratching, and peeling when transporting and handling the commercial product. Therefore, the surface of the resin layer 4 is required to have slip properties, scratch fastness and tape peeling resistance. Slip properties, scratch fastness and tape peeling resistance of the surface of the resin layer 4 can greatly be improved by containing any of a polysiloxane derivative, an atomized wax and a resin fine particle as an additive in the resin layer 4. As a result, a layered heat-shrink film having further excellent fastness properties can be realized.

Examples of the polysiloxane derivative that can preferably be used in the present invention include a polyether-modified polydimethylsiloxane, a polyether-modified polymethyl alkyl siloxane, a polyester-modified polydimethylsiloxane, a polyester-modified polyalkyl methylsiloxane and an aralkyl-modified polymethyl alkyl siloxane. Examples of the commercially available product of such a polysiloxane derivative include BYK-307 (trade name), BYK-310 (trade name), BYK-330 (trade name), BYK-333 (trade name) and BYK-344 (trade name), products of BYK Chemie, Japan; KP301 (trade name) and KP302 (trade name), products of Shin-Etsu Silicone Co.; and 11ADDITIVE (trade name), SH29PA (trade name), SH30PA (trade name), ST83PA (trade name), ST103PA (trade name), and ST115PA (trade name), products of Dow Corning Toray Silicone Co.

The polysiloxane derivative is added in a range of preferably from 0.1 to 3%, and more preferably from 0.5 to 2%, in weight ratio to the resin. Where the addition amount is smaller than 0.1%, the improvement effect to the above-described performance cannot be expected, and in many cases, the performance improvement effect to the addition amount is saturated in an amount of 3% or less. The atomized wax that can preferably be used in the present invention includes a polyethylene wax, a polypropylene wax, an amide wax and a carnauba wax. When a wax having a melting point in a range of from 50 to 150 degree is used, high slip properties and abrasion resistance can be imparted. Examples of the commercially available product of such an atomized wax include CERACOL 79 (trade name), CERACOL 601 (trade name), CERAFLOUR 990 (trade name), CERAFLOUR 991 (trade name), CERAFLOUR 994 (trade name) and CERAFLOUR 995 (trade name), products of BYK Chemie, Japan; and S-232 (trade name), S-394 (trade name), S-395 (trade name) and S-400 (trade name), products of SHARMROCK TECHNOLOGIES.

The atomized wax is added in a range of preferably from 0.5 to 10%, and more preferably from 1 to 5%, in weight ratio to the resin. Where the addition amount is smaller than 0.5%, the improvement effect to the above-described performance cannot be expected, and in many cases, the performance improvement effect to the addition amount is saturated in an amount of 10% or less.

Examples of the resin fine particle that can preferably be used in the present invention include a tetrafluoroethylene (PTFE) resin fine particle, a crosslinked acrylic resin fine particle and a crosslinked polystyrene resin fine particle.

Examples of the commercially available product of such a resin fine particle include CERAFLOUR 980 (trade name), a product of BYK Chemie, Japan; SST-2 (trade name), a product of SHAMROCK TECHNOLOGIES; and MBX SERIES (trade name), ARX SERIES (trade name) and SBX SERIES (trade name), products of Sekisui Plastics Co., Ltd.

The resin fine particle is added in a range of preferably from 0.5 to 10%, and more preferably from 1 to 5%, in weight ratio to the resin, similar to the atomized wax.

The polysiloxane derivative, atomized wax and resin fine particle may be combined and used.

Those additives are blended in the resin layer 4 by dissolving or dispersing the additives in the coating resin solution by various conventional methods.

In applying to a label and an outer covering, it is preferred that the resin material is transparent because of increasing degree of freedom on design. Where a reverse image is printed on the transparent ink absorbing layer 2 such that the transparent film substrate 1 is the outside (front side), the resin layer 4 constitutes an underlying layer or a light reflection layer. In general, in label printing, a white underlying layer (light reflection layer) is used in many cases. In such a case, the underlying layer (light reflection layer) can be constituted by the following two methods.

One method is a method of coloring the resin layer 4 by containing a coloring material in the resin. For example, the method comprises dispersing a while pigment such as titanium oxide or zinc oxide in the resin and holding the same therein, thereby forming a while resin layer 4. To form the resin layer 4 having the pigment dispersed and held therein, it is necessary to previously disperse the pigment in the coating resin solution. In this case, it is preferred that a dispersing agent is used, considering affinity between the pigment used, and the resin and the solvent. The dispersing agent can use surfactants and various commercially available polymeric materials, and is added in an amount of from about 1 to 10% in weight ratio to the resin. The pigment can be dispersed in the resin solution by the conventional method using various dispersers used in the production of paints and the like. The concentration of the pigment to the resin is preferably from about 5 to 30% in weight ratio. Where the concentration is less than 5%, it is difficult to obtain sufficient shielding properties and optical reflectivity. On the other hand, where the concentration exceeds 30%, colorability and shielding properties are not substantially improved any more. This invites unnecessary increase in costs, and the tendency is increased that water resistance and strength of the resin layer 4 deteriorate.

Another method is a method of forming a coloring layer or a light reflection layer on the resin layer 4 by printing, and is, for example, a method of forming the resin layer 4 and then conducting solid printing using a white ink.

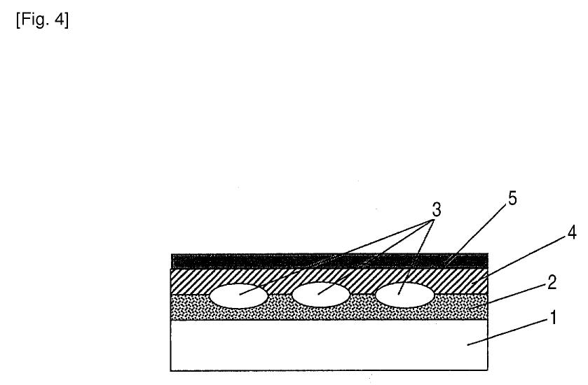

FIG. 4 is a cross sectional view schematically showing the cross section of the layered heat-shrink film according to the embodiment of the present invention.

In this case, various inks can be used so long as it is a material having wettability and adhesion to the resin layer 4. The printing method can use various conventional methods such as gravure printing, flexo printing, offset printing and applications by various coaters. When such a printing method is used, the ink layer has a sufficiently small thickness as about several mm or less. Therefore, the ink layer does not substantially affect shrink properties of the layered film. Furthermore, where solid printing is used, the influence giving to productivity is also small. Thus, in the method of forming a coloring layer or a light reflection layer by printing, it is not necessary to contain a pigment or the like in the resin layer 4. Therefore, there is the advantage on performance that water resistance and strength of the resin layer 4 are not decreased by mixing those.

The layered heat-shrink film according to the present invention comprises the film substrate 1, the ink absorbing layer 2 and the resin layer 4. It is preferred that the layered film has the overall thickness of 2 times or less the thickness of the film substrate 1 alone in order to secure heat shrinkability. Where the overall thickness exceeds 2 times, the ink absorbing layer 2 and the resin layer 4 generally used are a material which does not substantially exhibit heat shrinkability by itself. Therefore, there is the possibility that shrinkage of the film substrate 1 is suppressed when heat shrunk, thereby not reaching sufficient degree of shrinkage, and where adhesion is small or where high degree of shrinkage is required, the interface between the film substrate 1 and the ink absorbing layer 2 or the resin layer 4 peels in the course of shrinking, thereby causing the problems of wrinkle, film peeling and the like.

The ink absorbing layer 2 and the resin layer 4 that are preferred in the present invention are preferably that tensile modulus as a single film is from 0.5 to 2.0 GPa, and elongation at break in a tensile test as a single film is 10% or more. Where the tensile modulus is less than 0.5 GPa, the layer is liable to be scratched or deformed by physical external force such as scratching or rubbing in the stage of a product which is used as a label or an outer covering of a container. On the other hand, where the tensile modulus exceeds 2.0 GPa, there is the possibility that shrinkage of the film substrate 1 is suppressed at the time of heat shrinking, thereby not reaching sufficient degree of shrinkage, and where adhesion is small or where high degree of shrinkage is required, the interface between the film substrate 1 and the ink absorbing layer 2 or the resin layer 4 peels in the course of shrinking, thereby causing the problems of wrinkle, film peeling and the like. Where the elongation at break is less than 10%, the phenomenon (ink crack) is liable to be generated that the layer does not withstand local tensile tension generated at the film overlapped portion at the time heat shrinking, and the ink absorbing layer 2 and the resin layer 4, holding the coloring material are broken, thereby forming cracks in an image.

### EXAMPLES

Examples of the present invention are described below by referring to the drawings and tables, but the invention is not construed as being limited to those Examples.

### Example 1

Regarding each material of the ink absorbing layer 2 and the resin layer 4 in the present invention, classification, name and the like are shown in Table 1.

TABLE 1

| Structural site | Classification | Name |
|---|---|---|
| Ink absorbing | Base resin | Partially benzalated polyvinyl |
| layer | | alcohol resin |
| | | Polyvinyl pyrrolidone resin |
| | Water-soluble resin | Dicyandiamide cationic resin |
| | | Vinyl pyrrolidone resin |
| | Additive | Spherical resin powder |
| | | Polyether-modified silicone |
| | Solvent for | Water |
| | coating solution | 2-Propanol |
| Resin layer | Resin | Vinylidene chloride resin |
| | | Vinyl chloride-vinyl acetate resin |
| | | Styrene-butadiene resin A |
| | | Styrene-butadiene resin B |
| | Additive | Polyether-modified |
| | | polydimethylsiloxane |
| | | Atomized carnauba wax dispersion |
| | | (non-volatile content 20%) |
| | | PTFE resin fine particle |
| | Solvent for | Tetrahydrofuran |
| | coating solution | 2-Butanone |
| | | Cyclohexanone |

The polyvinyl pyrrolidone resin as the base resin for the ink absorbing layer 2 has a molecular weight of about 360,000, and the spherical resin powder as the additive is a HDPE type true spherical powder having a particle size of about 2 micro meters. The vinylidene chloride resin as the resin for the resin layer has a glass transition temperature of about 20 degree (nearly room temperature), a molecular weight of about 70,000 and a vinylidene chloride content of about 90%. The vinyl chloride-vinyl acetate resin has a glass transition temperature of about 75 degree, a molecular weight of about 40,000 and a vinylidene chloride content of about 90%. The styrene-butadiene resin A has a glass transition temperature of about 70 degree and a molecular weight of about 200,000. The styrene-butadiene resin B has a glass transition temperature of about 95 degree and a molecular weight of about 200,000. The polyether-modified polydimethylsiloxane as the additive for the resin layer is BYK-307 (trade name), a product of BYK Chemie, Japan, the atomized carnauba wax dispersion is CERACOL 601 (trade name), a product of BYK Chemie, Japan, and the PTFE resin fine powder is SST-2 (trade name), a product of SHAMROCK TECHNOLOGIES.

In Example 1, a biaxially stretched polyethylene terephthalate (PET) transparent heat-shrink sheet having a thickness of 40 mm was used as the film substrate 1. The film substrate 1 was cut into an A4 size, and an ink absorbing layer coating solution previously prepared comprising the formulation composition B in Table 2 was uniformly applied to the entire one side of the film substrate 1 by a bar coater at ordinary temperature so as to be about 150 g/m². The coated sheet thus obtained was allowed to stand in a dry oven at 60 degree for about 1 hour. Thus, a film sheet having a coating film thickness after drying, that is, a film thickness of the ink absorbing layer 2, of about 15 micro meters was obtained.

Compositions of the ink absorbing layer coating solution used in the experiment are shown in Table 2. In Example 1, the composition B in Table 2 is used as described above.

TABLE 2

| | | Composition of ink absorbing | | | | | |
|---|---|---|---|---|---|---|---|
| | | layer coating solution | | | | | |
| Material | | (parts by weight) | | | | | |
| Classification | Name | A | B | C | D | E | F |
| Base resin | Partially benzalated polyvinyl | 10 | 10 | 10 | 10 | 10 | — |
| | alcohol resin | | | | | | |
| | Acrylic water-soluble resin | — | — | — | — | — | 10 |
| Water-soluble resin | Dicyandiamide cationic resin | 0 | 1 | 2 | 3 | 4 | — |
| | Polyvinyl pyrrolidone resin | — | — | — | — | — | 2 |
| Additive | Spherical resin powder | 0.3 | 0.3 | 0.3 | 0.3 | 0.3 | 0.3 |
| | Polyether-modified silicone | 1 | 1 | 1 | 1 | 1 | 1 |
| Solvent | Water | 59.1 | 58.5 | 57.8 | 57.1 | 56.5 | 57.8 |
| | 2-Propanol | 29.6 | 29.2 | 28.9 | 28.6 | 28.2 | 28.9 |

The film sheet was printed using an ink-jet printer mounting a head having print resolution in sub-scanning direction of 600 dpi (dot/inch) and the number of nozzles of 400 pins, and capable of on-demand discharging three ink droplets having the droplet amount of about 13 μl at the maximum discharge frequency of 20 KHz. The print pattern was 10 mm*10 mm size, monochromic gradation patch pattern of total 10 kinds up to the maximum 100% solid at the interval of the degree of printing of 10% (dot arrangement by error diffusion method), and two color-overlapped pattern having the degree of printing of 100% (red, green and blue). After printing using four color water-based pigment inks 3 (black, cyan, magenta and yellow), respectively, the film sheet was allowed to stand at room temperature to dry.

Subsequently, the resin layer coating solution previously prepared comprising the formulation composition A in Table 3 was uniformly applied to the entire surface of the printed sheet by a bar coater at ordinary temperature such that a film thickness is about 15 micro meters. The coated sheet thus obtained was allowed to stand in a dry oven at 50 degree for about 2 hours. Thus, a layered heat-shrink film sheet having a coating film thickness after drying, that is, a film thickness of the resin layer 4 as a protective film, of about 15 micro meters was obtained.

Compositions of the resin layer coating solution used in the experiment are shown in Table 3. In Example 1, composition A in Table 3 is used as described above.

TABLE 3

| | | Composition of resin layer coating solution | | | | | | | |
|---|---|---|---|---|---|---|---|---|---|
| Material | | (part by weight) | | | | | | | |
| Classification | Name | A | B | C | D | E | F | G | H |
| Resin | Vinylidene chloride resin | 25 | 25 | 25 | — | — | — | — | — |
| | Vinyl chloride-vinyl acetate | — | — | — | 25 | 25 | 25 | — | — |
| | resin | | | | | | | | |
| | Styrene-butadiene resin A | — | — | — | — | — | — | 25 | — |
| | Styrene-butadiene resin B | — | — | — | — | — | — | — | 25 |
| Additive | Polyether-modified | 0.3 | — | — | 0.3 | 0.3 | 0.3 | 0.3 | 0.3 |
| | polydimethylsiloxane | | | | | | | | |
| | Atomized carnauba wax | — | 3.5 | — | — | — | — | — | — |
| | dispersion | | | | | | | | |
| | (non-volatile content 20%) | | | | | | | | |
| | PTFE resin fine particle | — | — | 0.7 | — | — | — | — | — |
| Solvent | Tetrahydrofuran | 74.7 | 71.5 | 74.3 | 74.7 | — | — | 74.7 | 74.7 |
| | 2-Butanone | — | — | — | — | 74.7 | — | — | — |
| | Cyclohexanone | — | — | — | — | — | 74.70 | — | — |

In the present invention, evaluation of swelling property of the ink absorbing layer 2 was concurrently conducted to select a preferred organic solvent in preparing the resin layer coating solution. Specific procedures of evaluation of swelling property are as follows. According to the above-described procedures, a sample having only the ink absorbing layer 2 formed on the film substrate 1 was dipped in three kinds of organic solvent of tetrahydrofuran, 2-butanone and cyclohexanone that are solvents shown in Table 3 at room temperature for 1 hour, and appearance of the ink absorbing layer 2 was then observed.

As a result, tetrahydrofuran and 2-butanone can swell each of compositions A, B and C (see Table 2) of the ink absorbing layer 2, and the layered heat-shrink films having formed thereon the resin layer using the those organic solvents showed high water resistance. On the other hand, cyclohexanone did not swell the ink absorbing layer 2, and the layered heat-shrink film having formed thereon the resin layer 4 using the organic solvent had poor water resistance as compared with the layered heat-shrink films having formed thereon the resin layer 4 using tetrahydrofuran and 2-butanone. It was seen from this result that when a material that can swell the ink absorbing layer 2 is used as the organic solvent for the resin layer coating solution, water resistance can further be improved. This effect is further specifically explained by Examples 6 to 8 described hereinafter.

The layered heat-shrink film sheet obtained by the above procedures was cut, and the respective cut sheets were used to examine image quality characteristics, heat-shrinkability and fastness properties.

The image quality characteristics were evaluated at the stage before shrinking the layered heat-shrink film sheet. Evaluation items of the image quality characteristics are three items of reflection density (OD (Optical Density) value) of a solid print portion, dot diameter and bleeding resistance. The reflection density was measured by placing a layered heat-shrink film sheet on which each color ink 3 was solid printed with drop measure of the ink 3 and resolution described above on a white paper, and measuring from the side of the resin layer 4 with D196 Model GRETAG reflection densitometer. The dot diameter was measured by setting a layered heat-shrink film sheet having isolated dot patterns printed thereon to an optical microscope equipped with XT stage, and measuring an equivalent diameter.

In general, when reflection density OD is 1.2 or larger, sufficient density contract as a print can be secured. Furthermore, when the print dot diameter is from 50 to 70 micro meters, thin spot of the dot alone is not recognized, and a print having high image quality combining resolution and high density is obtained.

The bleeding resistance was observed such that a halftone patch pattern having a degree of printing of from 50 to 90% is image treated with an error diffusion method and printed on the layered heat-shrink film sheet, and aggregation state of droplets of the ink 3 in the region on which plural dots are approached and arranged at the print portion is visually measured with an optical microscope. Even though the same layered heat-shrink film sheet, the image quality characteristics differ depending on the kind (color) of the ink 3. Therefore, the results of simple average of four colors were used as the integrated judgment.

The heat shrinkability was to see the characteristics of the layered heat-shrink film at the time of heat shrinking, and the evaluation items were two items of heat shrinkage follow-up properties and ink crack resistance. Of those, the heat shrinkage follow-up properties are the evaluation item that is used to judge as to whether or not non-shrinkable layers (absorbing layer and protective layer) can follow the shrinkage of the film substrate 1 and can shrink when heat is applied to the heat-shrink film sheet to closely pack the circumference of a container and the like.

Specific procedures are as follows. Two lengthwise edge portions in a shrinkage direction of a layered heat-shrink film sheet cut to a size of 290 mm length in a shrinkage direction and 90 mm length in a non-shrinkage direction were overlapped with a margin of 10 mm, and 5 to 10 portions of the margin were stapled with a stapler to form a cylindrical shape having a circumferential length of 280 mm. 200 ml mayonnaise bottle (outer diameter of body: 62 mm, peripheral length: 195 mm, and height: 107 mm) was covered with the cylindrical film. The mayonnaise bottle with the cylindrical film was dipped in hot water at 90 degree for about 10 seconds to shrink. In this case, the degree of shrinkage of the layered film on the body of the mayonnaise bottle is 30%.

It was visually judged as to whether or not wrinkle and film peeling were generated at the shrinkage portion of the layered heat-shrink film thus obtained, and the swelling is generated at the cut edge portion (sample periphery). The ink crack resistance is to evaluate the presence or absence of defective phenomenon and the degree thereof that the image (ink 3) cracks by that the film sheet locally receives tensile stress by concentration of stress generated at the margin (inside edge portion) having two sheet-overlapped state in the case of shrinking the layered heat-shrink film sheet. The specific procedures are as follows. A heat-shrink film substrate comprising the same material as the film substrate 1 was cut into a strip shape having a thickness of 40 micro meters, a width of 8 mm (heat shrinkage direction) and a length of 100 mm. Three strips were arranged on the periphery of a mayonnaise bottle at a constant interval. The mayonnaise bottle with three strips was covered with a cylindrical layered heat-shrink film sheet and the assembly was shrunk, in the same manners as in the above-described shrinkage follow-up properties. It was evaluated by appearance observation with an optical microscope as to whether or not chap and crack are generated in the image at the margin (inside edge portion).

The fastness properties are to judge physical and chemical durability of the layered heat-shrink film after heat shrinking. The specific evaluation items are four items of scratch fastness, adhesion, chemical resistance and water resistance, and for the purpose of observing change with the passage of time of those four characteristics, environmental shelf durability was also conducted. The test piece used in each item was a layered heat-shrink film having a size of about 60 mm*60 mm prepared by previously printing monochromatic solid patch pattern (degree of printing: 100%) of black, cyan, magenta and yellow, and two color-overlapped solid patch pattern (degree of printing: 200%) of red, green and blue, and forming the resin layer 4. In each item, the same evaluation was conducted with test pieces before and after heat shrinkage, and the repeating number was 3 in each item.

The scratch fastness was evaluated by carrying out both so-called scratch test and crease-flex test. Specific evaluation procedure of the scratch method is as followed. A layered heat-shrink film test piece was placed on a desk, the resin layer 4 side surface of the film substrate 1 was reciprocally rubbed with the back of a fingernail in a stretching direction about 10 times, and the presence or absence and the degree of the damage to the resin layer 4 and an image were evaluated. The crease-flex test was carried out as follows. Two extremities of a layered heat-shrink film test piece were held with both hands, the both hands were alternatively reciprocated 5 times in a state of touching surfaces of the resin layer 4, and the presence or absence and the degree of the damage to the resin layer 4 and an image were evaluated.

The adhesion was evaluated by a so-called tape peel test. The specific procedure of the tape peel test is as follows. A given cellophane tape (a product of Nichiban Co., Ltd., width: 18 mm) was stuck and sufficiently adhered to a monochromic solid print portion and two color-overlapped print portion on the protective layer surface side of a layered heat-shrink film sheet, with a length of about 50 mm. The cellophane tape was vigorously peeled from the edge in the longitudinal direction thereof at an angle of about 90 degree to the surface of the layered heat-shrink film sheet test piece, and the presence or absence and the degree of damage to the resin layer 4 and an image were observed.

For the chemical resistance, an ethanol drop test was carried out. One droplet of ethanol (purity: 98% or higher) was dropped with a dropper on 3 to 4 spots on the protective layer surface side of a layered heat-shrink film sheet. The droplets were allowed to stand in a thermostat chamber at 40 degree for 24 hours to dry the same. It was evaluated by examining whether or not trace of whitening is generated on the dropped spot.

For the water resistance, a hot water dip test was carried out. Non-print portion of a layered heat-shrink film sheet was cut into a 60 mm*60 mm size having a width of about 10 mm at the periphery as a test piece. The test piece was dipped in hot water controlled to a temperature of 40 degree for 7 days, and the appearance change was observed and evaluated. The reason that the non-print portion is arranged on the periphery is to make easy to observe impregnation state of water from cut portion of a film having no protective function by the resin layer 4, and further appearance such as whitening due to water impregnation and the presence or absence of shape change.

For the environmental shelf durability, a high temperature and high humidity environmental shelf test was carried out. This test is to observe change of fastness properties by being allowed to stand for long period of time. Specific procedure of the test is as follows. A test piece having a given shape was introduced into a thermo-hygrostat for environmental test adjusted to a temperature of 50 degree and a humidity of 80%.

After being allowed to stand for 7 days, the test piece was taken out of the thermo-hygrostat as a layered heat-shrink film test piece having been subjected to environmental shelf. The total four items of the above-described fastness property test were carried out in the same evaluation procedures, and it was judged by evaluating the presence or absence and the degree of deterioration from the initial performance.

As described above, in Example 1, B in Table 2 as the composition of an ink absorbing layer coating solution for forming the ink absorbing layer 2 was applied such that the ink absorbing layer 2 has a film thickness after drying of 15 micro meters, and A in Table 3 as the composition of a resin layer coating solution for forming the resin layer 4 was applied such that the resin layer 4 has a film thickness after drying of 15 micro meters.

The results of using such a combination are shown in Example 1 of Table 4. It was confirmed that the layered heat-shrink film sheet produced combines practically sufficient image quality and fastness properties, and has very excellent characteristics.

The bleeding, adhesion, water resistance and chemical resistance were evaluated by visual qualitative evaluation, and judged according to the following indexes.

TABLE 4

| | | Ex. 1 | Ex. 2 | Ex. 3 | Ex. 4 | Ex. 5 | Ex. 6 | Ex. 7 | Ex. 8 | Ex. 9 | Ex. 10 | Ex. 11 | Ex. 12 | Ex. 13 | Ex. 14 |
|---|---|---|---|---|---|---|---|---|---|---|---|---|---|---|---|
| Constitution | Composition of ink | B | C | D | C | C | C | C | C | C | C | C | C | C | C |
| | absorbing layer | | | | | | | | | | | | | | |
| | Thickness of ink | 15 | 15 | 15 | 15 | 15 | 15 | 15 | 15 | 15 | 10 | 15 | 15 | 25 | 30 |
| | absorbing layer | | | | | | | | | | | | | | |
| | (μm) | | | | | | | | | | | | | | |
| | Composition of | A | A | A | B | C | D | E | F | G | A | A | D | A | A |
| | resin layer | | | | | | | | | | | | | | |
| | Thickness of resin | 15 | 15 | 15 | 15 | 15 | 15 | 15 | 15 | 15 | 15 | 5 | 5 | 15 | 10 |
| | layer (μm) | | | | | | | | | | | | | | |
| Image quality | Reflection density | (B) | (A) | (B) | (A) | (A) | (A) | (A) | (A) | (A) | (A) | (A) | (A) | (A) | (A) |
| | Dot diameter | (B) | (B) | (B) | (B) | (B) | (B) | (B) | (B) | (B) | (B) | (B) | (B) | (B) | (B) |
| | Bleeding resistance | (B) | (B) | (A) | (B) | (B) | (B) | (B) | (B) | (B) | (B) | (B) | (B) | (B) | (B) |
| Heat | Heat shrinkage | (A) | (A) | (A) | (A) | (A) | (A) | (A) | (A) | (A) | (A) | (A) | (A) | (A) | (A) |
| shrinkability | follow-up property | | | | | | | | | | | | | | |
| | Ink crack resistance | (A) | (A) | (A) | (A) | (A) | (A) | (A) | (A) | (A) | (A) | (A) | (A) | (A) | (A) |
| Fastness | Scratch fastness | (A) | (A) | (A) | (A) | (A) | (A) | (A) | (A) | (A) | (A) | (B) | (B) | (B) | (B) |
| properties | Adhesion | (A) | (A) | (A) | (A) | (A) | (A) | (A) | (A) | (B) | (A) | (A) | (B) | (B) | (B) |
| | Chemical resistance | (A) | (A) | (A) | (A) | (A) | (A) | (A) | (A) | (A) | (A) | (A) | (A) | (A) | (A) |
| | Water resistance | (A) | (A) | (A) | (A) | (A) | (A) | (A) | (B) | (B) | (A) | (A) | (A) | (A) | (A) |
| | High temperature | (A) | (A) | (A) | (A) | (A) | (A) | (A) | (A) | (A) | (A) | (A) | (A) | (A) | (A) |
| | high humidity | | | | | | | | | | | | | | |
| | environmental | | | | | | | | | | | | | | |
| | shelf durability | | | | | | | | | | | | | | |

Reflection Density (OD Value):

The reflection density was classified into the following four grades by the degree (large, small) of an optical reflection density on a monochromic solid print portion, and judged.

(A): OD>1.5

(B): 1.2<=OD<=1.5

(C): 1.0<=OD<=1.2

(D): OD<1.0

Dot Diameter:

(A): 60 micro meters<=dot diameter<=70 micro meters

(B): 55 micro meters <=dot diameter<=60 micro meters

(C): 50 micro meters <=dot diameter<=55 micro meters

(D): Dot diameter<50 micro meters, dot diameter>70 micro meters

Bleeding Resistance:

The bleeding resistance was classified into the following four grades according to aggregative degree of nearby dots (3 ink droplets), and judged.

(A): Aggregation does not occur, and dot shape and ink landing position are substantially held. No image deterioration.

(B): Aggregation slightly occurs, and image deterioration is not visually recognized.

(C): Aggregation occurs, shading is visually observed, and image deterioration is recognized.

(D): Aggregation occurs in large scale, and image deterioration due to uneven shading is remarkable.

Heat Shrinkage Follow-Up Property:

The heat shrinkage follow-up property was made by classifying the presence or absence and the degree of wrinkle and peeling after heat shrinking into the following four grades, and then judging.

(A): Wrinkle and peeling are not recognized by heat shrinkage.

(B): Slight wrinkle and peeling are observed by heat shrinkage.

(C): Wrinkle and peeling are observed by heat shrinkage.

(D): Remarkable wrinkle and peeling are observed by heat shrinkage.

Ink Crack Resistance:

The ink crack resistance was made by classifying image state of a film-overlapped portion after heat shrinking into the following four grades, and then judging.

(A): Crack is not generated on an image at all.

(B): Crack is slightly generated on an image.

(C): Crack is generated in spots on an image.

(D): Continuous crack is generated on an image.

Scratch Fastness:

The scratch fastness was totally evaluated by carrying out both the scratch test and the crease-flex test. It was classified into the following four grades according to the peeling state of the resin layer 4, and judged.

(A): Peeling and image quality deterioration do not occur.

(B): Peeling and image deterioration are slightly observed.

(C): Peeling and image deterioration are observed.

(D): Peeling and image deterioration are observed in large scale.

Adhesion:

The adhesion test was carried out by a tape peel test. It was classified into the following four grades according to peeling state of the protective layer (or protective layer and absorbing layer) after the test, and judged.

(A): Peeling and image quality deterioration do not occur.

(B): Peeling and image deterioration are slightly observed.

(C): Peeling and image quality deterioration are observed.

(D): Peeling and image quality deterioration are observed in large scale.

Chemical Resistance:

The chemical resistance was carried out by classifying into the following four grades according to the presence or absence and the degree of droplet trace of ethanol, and evaluated.

(A): Droplet trace is not observed, and there is no damage.

(B): Droplet trace is slight, and there is substantially no damage.

(C): Droplet trace is observed, and there is appearance change such as whitening.

(D): Droplet trace is observed, and appearance change is remarkable.

Water Resistance:

The water resistance was judged by classifying into the following four grades according to the presence or absence and the degree of change of sample appearance.

(A): Including a transparent portion (non-print portion of sample circumference), appearance change such as whitening and peeling are not observed.

(B): Transparent portion (non-print portion of sample circumference) is slightly whitened. Shape change such as peeling is not observed.

(C): Shape change such as whitening and peeling are observed on a sample.

(D): An absorbing layer and a resin layer 4 are peeled and dropped on the entire surface of a film substrate 1.

Environmental Shelf Durability:

The environmental shelf durability was classified into the following four grades according to the presence or absence and the degree of performance deterioration in the total four items of the above-described fastness property test after high temperature and high humidity environmental shelf, and judged.

(A): There is no deterioration from the initial performance in all items of fastness properties.

(B): Slight deterioration from the initial performance is observed in a part of items of fastness properties.

(C): Deterioration from the initial performance is observed in a part or all of items of fastness properties.

(D): Considerable deterioration from the initial performance is observed in a part or all of items of fastness properties.

### Examples 2 to 14

A layered heat-shrink film comprising film substrate 1/ink absorbing layer 2/water-based pigment ink 3/resin layer 4 was prepared, and its characteristics were evaluated, in the same manners as in Example 1, except for blending ratio and kind of the ink absorbing layer coating solution used for forming the ink absorbing layer 2 and the resin layer coating solution used for forming the resin layer 4 as a protective layer.

The composition of each ink absorbing layer coating solution used is shown in B to D of Table 2, and the composition of each resin layer coating solution is shown in A to G of Table 3. Examples 2 to 14 are layered heat-shrink films prepared by variously combining each coating solution, and layer structure and characteristic evaluation results (image quality, heat shrinkability and fastness properties) of the respective films are shown in Table 4.

Of Examples 2 to 14, Examples 6 to 8 are the example to show that water resistance of the layered heat-shrink film can be improved by using a material that can swell the ink absorbing layer 2 (tetrahydrofuran and 2-butanone as previously described) as an organic solvent used in the resin layer coating solution. It is the experimental results when the composition and film thickness of the ink absorbing layer 2, the resin constituting the resin layer, the composition of additives, and film thickness are the same, and only an organic solvent of the resin layer coating solution is changed as shown in D, E and F of Table 3.

As shown in Table 4, when tetrahydrofuran which can swell the ink absorbing layer 2 is used as an organic solvent (Composition D, Example 6), and when 2-butanone is used as an organic solvent (Composition E, Example 7), water resistance is further excellent as compared with the case of using cyclohexanone which does not swell the ink absorbing layer 2 (Composition F, Example 8).

### Comparative Examples 1 to 10

A layered heat-shrink film comprising film substrate 1/ink absorbing layer 2/water-based pigment ink 3/resin layer 4 was prepared, and its characteristics were evaluated, in the same manners as in Example 1, except for changing the blending ratio and the kind of the ink absorbing layer 2 and the resin layer 4. The composition of each ink absorbing layer 2 used is shown in A, E and F of Table 2, and the composition of each resin layer coating solution is shown in A, D and H of Table 3. Comparative Examples 1 to 10 are layered heat-shrink films prepared by variously combining the above-described each coating solution, and the respective layer structures and characteristic evaluation results (image quality, heat shrinkability and fastness properties) are shown in Table 5.

TABLE 5

| | | Com. | Com. | Com. | Com. | Com. | Com. | Com. | Com. | Com. | Com. |
|---|---|---|---|---|---|---|---|---|---|---|---|
| | | Ex. 1 | Ex. 2 | Ex. 3 | Ex. 4 | Ex. 5 | Ex. 6 | Ex. 7 | Ex. 8 | Ex. 8 | Ex. 10 |
| Structure | Composition of ink | A | E | C | C | C | F | C | C | C | C |
| | absorbing layer | | | | | | | | | | |
| | Thickness of ink | 15 | 15 | 5 | 15 | 15 | 15 | 15 | 15 | 30 | 30 |
| | absorbing layer (μm) | | | | | | | | | | |
| | Composition of resin | A | A | A | A | D | A | H | None | A | A |
| | layer | | | | | | | | | | |
| | Thickness of resin | 15 | 15 | 15 | 2 | 2 | 15 | 15 | — | 15 | 20 |
| | layer (μm) | | | | | | | | | | |
| Image | Reflection density | (B) | (B) | (B) | (A) | (A) | (D) | (A) | (A) | (A) | (A) |
| Quality | Dot diameter | (C) | (C) | (C) | (B) | (B) | (D) | (B) | (B) | (B) | (B) |
| | Bleeding resistance | (C) | (C) | (C) | (B) | (B) | (A) | (B) | (B) | (B) | (B) |
| Heat | Heat shrinkage | (A) | (C) | (A) | (A) | (A) | (A) | (D) | (A) | (C) | (D) |
| shrinkability | follow-up property | | | | | | | | | | |
| | Ink crack resistance | (A) | (C) | (A) | (A) | (B) | (C) | — | (D) | (B) | (B) |
| Fastness | Scratch fastness | (A) | (A) | (A) | (C) | (C) | (A) | — | (D) | (C) | (D) |
| Properties | Adhesion | (A) | (A) | (A) | (C) | (C) | (A) | — | (D) | (C) | (C) |
| | Chemical resistance | (A) | (A) | (A) | (A) | (A) | (A) | — | (D) | (A) | (A) |
| | Water resistance | (A) | (C) | (A) | (B) | (B) | (C) | — | (D) | (A) | (A) |
| | High temperature and | (A) | (A) | (A) | (A) | (A) | (C) | — | (D) | (C) | (C) |
| | high humidity | | | | | | | | | | |
| | environmental shelf | | | | | | | | | | |
| | durability | | | | | | | | | | |

### Examples 15 to 19

Viscoelastic characteristic evaluation was carried out by a tensile tester to examine physical property range (mechanical characteristic) of a non-shrink material (ink absorbing layer 2 and resin layer 4) which is required for a layered heat-shrink film to show the desired heat shrinkability and scratch fastness. Two-layer film (layered film) samples having various viscoelastic characteristics comprising the ink absorbing layer 2 and the resin layer 4 were prepared as measurement samples in the same manners as in Example 1. The relationship between the heat shrinkability and scratch fastness in the state that the respective sample is laminated on the film substrate 1, that is, in the state of a layered heat-shrink film, was examined in detail.

Two-layer film samples having various elastic modulus and layered heat-shrink films were prepared by changing the ratio of a low modulus material and a high modulus material as shown in Table 6 in the preparation stage of each coating liquid of the ink absorbing layer 2 and the resin layer 4 shown in Example 1.

Measurement method of viscoelastic characteristic was conducted as follows. Non-print portion of each sheet-like layered heat-shrink film was cut into a strip having a width of 10 mm and a length of 50 mm. A two-layer film comprising the ink absorbing layer 2 and the resin layer 4 was carefully peeled from the film substrate 1 starting from the cut edge in a longitudinal direction as a starting point. The two-layer film sample thus obtained was fixed to a tensile tester (1305N, Aikoh Corporation) with a chuck jig such that a longitudinal direction is up and down so that an initial length in a tensile direction is 10 mm and a width is 10 mm. Elongation amount of the sample and load amount (tension) to a load cell arranged in series to the sample were simultaneously monitored while pulling both extremities of the sample at a constant rate of 3.5 mm/min.

Elongation amount vs. tension were loaded in PC as data, and the measurement was stopped at the time that any layer in the two-layer film sample was broken. The tensile modulus was obtained from elongation amount and tension value in an initial stage of pulling initiation (degree of elongation: within 2%) and a sample shape (cross section). Furthermore, it was calculated by degree of elongation (%) (elongation amount/initial length)*100.

On the other hand, evaluation of the heat shrinkage and the scratch fastness was carried out by the method described in Example 1, without peeling the two-layer film sample from the film substrate 1, and good and poor were judged. The characteristic evaluation results are shown in Table 6.

### Comparative Examples 11 to 14

Two-layer film samples having various viscoelastic characteristics and layered heat-shrink films using the two-layer film samples were prepared in the same manners as in Examples 15 to 19, and characteristic evaluation was carried out. The two-layer film samples and the characteristic evaluation results are shown in Table 6.

As shown in Table 6, it is preferred as mechanical characteristics of a two-layer film sample which is required for a layered heat-shrink film to have the desired characteristics (heat shrinkage and scratch fastness) that the tensile modulus is in a range of from 0.5 to 2.0 GPa and the degree of elongation at break is 10% or higher. Furthermore, the specific means for achieving the preferred range of those mechanical characteristics is realized by appropriately preparing the composition of each material of the two-layer film, particularly the composition of the resin layer 4. When a vinyl chloride-vinyl acetate resin and a styrene-butadiene rubber are used as the material of the resin layer 4, preferred tensile modulus and degree of elongation are realized when the compositional ratio of the vinyl chloride-vinyl acetate resin constituting the resin layer 4 is from 30 to 70%, and a layered heat-shrink film having the desired characteristics (heat shrinkability and scratch fastness) is obtained.

Where the tensile modulus (elastic modulus) is less than 0.5 GPa, the film is too soft, and therefore is liable to be scratched with physical external force such as scratching or rubbing and to be deformed, at the stage of a product used as a container label or outer covering. On the other hand, where the tensile modulus exceeds 2.0 GPa, the film is too hard. Therefore, there is the possibility that shrinkage of the film substrate 1 is suppressed at the time of heat shrinking, thereby not reaching sufficient degree of shrinkage, and where adhesion is poor and where high degree of shrinkage is required, peeling occurs between the film substrate 1 and the ink absorbing layer 4 or the resin layer 4 in the course of shrinking, thereby inducing problems such as wrinkle and film peeling.

Where the elongation at break is less than 10%, the layered heat-shrink film does not withstand local tensile tension generated at the film-overlapped portion at the time of heat shrinking, and defect phenomenon such that the ink absorbing layer 2 and the resin layer 4 holding a coloring material are broken, thereby forming cracks on an image (ink crack) is liable to cause.

Examples 15 to 19 are to note the heat shrinkability and scratch fastness in various characteristics of the layered heat-shrink film, and to define the range of mechanical characteristics of a two-layer film sample necessary for the films to have the desired characteristics. Therefore, as far as the heat shrinkability and scratch fastness of a layered heat-shrink film are concerned, where the mechanical characteristics (tensile modulus and degree of elongation) are within the above range, the range of material selection is not limited, and materials and compositions other than the present Examples may be used.

TABLE 6

| | Composition of two-layer film | | | | | | | | | | | | |
|---|---|---|---|---|---|---|---|---|---|---|---|---|---|
| | (layered film) sample | | | | Mechanical characteristics | | | | | | | | |
| | Blend ratio | | Blend ratio of | | of two-layer film | | | | | Evaluation of layered | | | |
| | of ink | | resin layer | | (layered film) sample | | | | | heat-shrink film | | | |
| | absorbing layer | | Vinyl | | | Yield point | | Fracture point | | Heat shrinkability | | | |
| | Poly- | Acrylic | chloride- | | | Degree | Maxi- | Degree | | Heat | Ink | Scratch fastness | |
| | vinyl | water- | vinyl | Styrene- | Scratch | of | mum | of | Tensile | shrinkage | cracks | | Crease- |
| | alcohol | soluble | acetate | butadiene | fastness | elongation | tension | elongation | strength | follow-up | resist- | Scratch | flex |
| | resin | resin | resin | rubber | (GPa) | (%) | (N) | (%) | (N) | property | ance | test | test |
| Example 15 | 70 | 30 | 30 | 70 | 0.5 | 6 | 3 | 120 | 3 | (A) | (A) | (B) | (B) |
| Example 16 | 70 | 30 | 40 | 60 | 0.7 | 5 | 3 | 100 | 3 | (A) | (A) | (A) | (A) |
| Example 17 | 70 | 30 | 50 | 50 | 1.0 | 5 | 3 | 50 | 3 | (A) | (A) | (A) | (A) |
| Example 18 | 70 | 30 | 60 | 40 | 1.5 | 5 | 3 | 20 | 3 | (A) | (A) | (A) | (B) |
| Example 19 | 80 | 20 | 70 | 30 | 2.0 | 4 | 3 | 10 | 3 | (B) | (B) | (A) | (B) |
| Comparative | 70 | 30 | 0 | 100 | 0.2 | 8 | 5 | 200 | 4 | (A) | (A) | (D) | (D) |
| Example 11 | | | | | | | | | | | | | |
| Comparative | 70 | 30 | 20 | 80 | 0.3 | 6 | 4 | 150 | 3 | (A) | (A) | (C) | (C) |
| Example 12 | | | | | | | | | | | | | |
| Comparative | 90 | 10 | 80 | 20 | 2.4 | 3 | 3 | 5 | 3 | (C) | (C) | (A) | (C) |
| Example 13 | | | | | | | | | | | | | |
| Comparative | 100 | 0 | 100 | 0 | 3.0 | 2 | 3 | 2 | 3 | (D) | (D) | (A) | (D) |
| Example 14 | | | | | | | | | | | | | |

### Example 20

An oil-based white ink, OS-M701 White (trade name), a product of Dainichiseika Color & Chemicals Mgf., Co., Ltd., was printed by application on the resin layer 4 of the layered heat-shrink film of Example 3 by a bar coater, and dried at 50 degree to form a white colored layer having a thickness of about 2 micro meters. The heat shrinkage and fastness properties of the layered film with the colored layer were evaluated in the same manners as in the above-described Examples. As a result, excellent results similar to Example 3 were obtained in each item.

### Example 21

The layered heat-shrink films prepared in Examples 1 to 20 were applied as an exterior label of glass containers and PET bottles, and containers as a completed product were prepared.

A layered heat-shrink film having been subjected to printing using a water-based ink-jet method was prepared according to the above-described steps. The degree of shrinkage was set to 30%, and the layered heat-shrink film was cut into the desired size such that the layered heat-shrink film after shrinking corresponds to an external size of a glass container and a PET bottle. Both extremities in a shrink direction were overlapped at margins of about 3 mm, and the margins were adhered with an adhesive. The cylindrical layered heat-shrink film obtained was further subjected to bag-making, and a glass container and a PET bottle were covered with the cylindrical film. The film-covered glass container and PET bottle were dipped in 90 degree hot water (that is, a temperature higher than a shrinkage initiation temperature of the film substrate 1 and a glass transition temperature of a thermoplastic resin constituting the resin layer 4) and shrunk.

The container thus obtained maintained extremely good external form without generation of wrinkle and film peeling on the shrunk portion of the layered heat-shrink film as an external label, and was excellent in scratch fastness, tape peel resistance and water resistance to the printed surface. Furthermore, even when the layered heat-shrink film is formed into a cylindrical shape without bag-making into a bag shape, the container is covered with the cylindrical film, and the container with the film is shrunk, a label having excellent scratch fastness, tape peel resistance and water resistance of printed surface could be constituted.

As described above, when the hydrophilic ink absorbing layer 2 is formed on one side of the film substrate 1 having heat shrinkability, printing is conducted by discharging the water-based pigment ink 3 by an ink-jet method, and the thermoplastic resin layer 4 that can shrink along heat shrinkage of the film substrate 1 and has water resistance and scratch fastness is formed on the printed surface, a heat-shrink film that can perform fine plateless printing and has excellent fastness properties can be realized.

Furthermore, when the ink absorbing layer 2 contains a partially benzalated polyvinyl alcohol and a dicyandiamide type cationic resin, the content of the dicyandiamide type cationic resin is from 10 to 30% in weight ratio to the content of the partially benzalated polyvinyl alcohol, and the ink absorbing layer 4 has a thickness of 10 micro meters or more, the ink absorbing layer 2 having excellent balance between liquid absorption ability and water resistance can be constituted, and high definition image can be formed.

When the resin layer 4 is formed by a thermoplastic resin having a glass transition temperature lower than a heat shrinkage temperature of the film substrate 1, excellent heat shrinkability can be obtained.

When a vinylidene chloride copolymer or a vinyl chloride-vinyl acetate copolymer is used as a thermoplastic resin, and the resin layer 4 has a thickness of 5 micro meters or more, a layered heat-shrink film having excellent fastness properties can be realized.

When a material having the property capable of swelling the ink absorbing layer 2 is used as an organic solvent used in coating the resin layer 4, a heat-shrink film having further high water resistance can be realized even in the case of using the same resin.

When the layered heat-shrink film has a thickness of two times or less the thickness of the layered heat-shrink film substrate 1 alone, good heat shrinkability can be realized without inducing wrinkle and film peeling at the time of heat shrinking.

When the ink absorbing layer 2 and the resin layer 4 have tensile modulus of from 0.5 to 2.0 GPa and a degree of elongation at break in a tensile test of 10% or more, a layered heat-shrink film that withstands local tensile tension generated at the film-overlapped portion at the time of heat shrinking, thereby maintaining high definition image without receiving damage in the ink absorbing layer 2 and the resin layer 4, and is provided with high image fastness properties durable to physical external force such as scratching and rubbing even in the form of a label and a packaging film after heat shrinking can be realized.

### INDUSTRIAL APPLICABILITY

According to the present invention, fine plateless printing by a water-based ink-jet method is possible, a heat-shrink film having excellent fastness properties can be realized, and deterioration of the printed surface by water wetting, high humidity environmental shelf and external force such as rubbing and bending can be prevented, that is, water resistance and scratch fastness can be imparted to the printed surface.

The layered heat-shrink film of the present invention comprises a substrate having heat shrinkability, an ink absorbing layer, and a protective layer comprising as a main component a resin that shrinks along heat shrinkage of the substrate, wherein the ink absorbing layer is interposed between the substrate and the protective layer.

By this constitution, fine plateless printing by a water-based ink-jet method is possible, a heat-shrink film having excellent fastness properties can be realized, and deterioration of the printed surface by water wetting, high humidity environmental shelf and external force such as rubbing and bending can be prevented, that is, water resistance and scratch fastness can be imparted to the printed surface.

The present invention is to form a print image on the ink absorbing layer by a water-based ink-jet method.

It is possible to easily respond to a small lot production due to low-volume high-mix production and diversification of design by employing a plateless printing method that enables on-demand, such as an ink-jet method.

Furthermore, the present invention is that the protective layer is constituted of a thermoplastic resin having water resistance and scratch fastness.

This constitution makes it possible to impart excellent water resistance and scratch fastness onto the printed surface.

The present invention is further that the ink absorbing layer is constituted of a swelling-type material containing a water-absorptive resin. When the ink absorbing layer is formed as a swelling-type absorbing layer containing a water-absorptive resin, thereby imparting hydrophilicity, the swelling-type absorbing layer has good follow-up property to shrinkage as compared with a micropore-type absorbing layer generally used in papers for ink-jet printing. Therefore, the follow-up property to heat shrinkage of the film substrate is good, and it is possible to form an ink absorbing layer having high transparency.

The present invention is that the protective layer contains an organic solvent that swells the ink absorbing layer. The term “swelling” used herein means a phenomenon that the ink absorbing layer swells by absorbing an organic solvent. In this case, it is considered that a thermoplastic resin dissolved in the organic solvent is capable of being incorporated into the ink absorbing layer together with the organic solvent.

This makes it possible to surely impregnate the ink absorbing layer with the thermoplastic resin.

Thus, when the ink absorbing layer is impregnated with the thermoplastic resin, even in the case that the layered heat-shrink film of the present invention is cut at any portion, under normal circumstances the cut cross section is that the ink absorbing layer is directly exposed, and water is absorbed from the portion, thereby the layered heat-shrink film deteriorates. However, because the ink absorbing layer is impregnated with the thermoplastic resin, the ink absorbing layer is not exposed in its form at the cut portion, and the proportion of absorbing water is small. As a result, the degree of deterioration is small as the layered heat-shrink film.

The present invention is constituted such that the swelling type ink absorbing layer contains a partially benzalated polyvinyl alcohol and a dicyandiamide type cationic resin.

This can constitutes the ink absorbing layer having excellent balance between liquid absorption ability and water resistance, thereby making it possible to form a high definition image on the layered heat-shrink film.

The present invention is that the content of the dicyandiamide type cationic resin constituting the swelling type ink absorbing layer is from 10 to 30 wt % based on the content of the partially benzalated polyvinyl alcohol.

This can constitutes the ink absorbing layer having excellent balance between liquid absorption ability and water resistance, thereby making it possible to form a high definition image on the layered heat-shrink film.

The present invention is that the ink absorbing layer contains any one of a spherical resin powder and a polyether-modified silicone as an additive.

This can improve blocking resistance and leveling property, thereby realizing high dot circularity by ink droplets. As a result, it is possible to obtain a high definition image molding as a rolled film having high productivity.

The present invention is constituted such that the ink absorbing layer has a film thickness of 10 micro meters or more.

This makes it possible to surely fix a water-based ink to the ink absorbing layer while maintaining high image quality.

The present invention is that the protective layer is constituted of a thermoplastic resin, and the thermoplastic protective layer has a glass transition temperature lower than the heat shrinkage temperature of the substrate.

This forms the state that at the heat shrinkage temperature of the film substrate, the thermoplastic resin is in a temperature higher than the glass transition temperature thereof, and micro-Brownian motion of molecule is released. As a result, excellent follow-up property to heat shrinkage of the substrate can be secured, and it is possible to realize a layered heat-shrink film having high shrinkability without causing wrinkle and peeling in the resin layer.

The present invention is that the protective layer is constituted of a vinylidene chloride copolymer or a vinyl chloride-vinyl acetate copolymer, which is a thermoplastic resin.

This can form a resin layer having very high water resistance, moisture resistance and strength. As a result, it is possible to realize a layered heat-shrink film having particularly excellent fastness properties.

The present invention is that the protective layer contains any one of a polysiloxane derivative, an atomized wax and a resin fine particle as an additive.

This can improve slippage property and scratch fastness of the resin layer surface, and tape peel resistance, and as a result, it is possible to realize a layered heat-shrink film having excellent fastness properties.

The present invention is that the protective layer has a film thickness of 5 micro meters or more.

This can improve slippage property and scratch fastness of the resin layer surface which functions as a protective layer, and tape peel resistance, and as a result, it is possible to realize a layered heat-shrink film having excellent fastness properties.

The present invention is that the substrate is constituted of a polyester stretched film.

When the polyester stretched film having high chemical resistance is used as the substrate, even though a thermoplastic resin solution constituting the protective layer is applied to the substrate, the film substrate is not affected by an organic solvent as a solvent of the thermoplastic resin solution. As a result, choice of the thermoplastic resin is expanded, and additionally it is possible to prevent damage to a film.

The present invention is that a colored film is formed on the protective layer by printing.

This makes it possible to impart the function such as a light reflection layer onto the protective layer in the case of the constitution such that the protective layer faces inside the container.

The present invention is that an image having printed dot diameter of from 55 to 70 micro meters and reflection density at monochromic solid print portion of 1.2 or more is formed on the ink absorbing layer.

This makes it possible to obtain sufficient resolution and density contrast as a print.

The present invention is that the substrate has heat shrinkability of 30% or more.

This can attempt to secure performance as a layered heat-shrink film.

The present invention is that the layered heat-shrink film has a film thickness of 2 times or less the film thickness of the substrate alone as a heat-shrink film.

This makes it possible to realize good heat shrinkability without causing wrinkle and film peeling at the time of heat shrinking even though using an ink absorbing layer material and a protective layer material, that do not substantially show heat shrinkability by themselves.

The present invention is that a layered film constituted of the ink absorbing layer and the protective layer (resin layer) has a tensile modulus of from 0.5 to 2.0 GPa, and a degree of elongation at break in a tensile test of 10% or more.

This can realize a layered heat shrink film that withstands local tensile tension generated at the film-overlapped portion at the time of heat shrinking, thereby maintaining high definition image without receiving damage in the ink absorbing layer and the resin layer, and is provided with high image fastness properties durable to physical external force such as scratching and rubbing even in the form of a label and a packaging film after heat shrinking.

A method for producing a layered heat-shrink film of the present invention comprises a step of forming an ink absorbing layer having hydrophilicity on a substrate having heat shrinkability, a step of forming a print image on the ink absorbing layer by a water-based ink-jet method, a step of applying a solution of a thermoplastic resin dissolved in an organic solvent to the print side, and a step of evaporating the organic solvent at a temperature lower than a temperature at which the substrate initiates to shrink, thereby forming a protective layer.

This method can form a thin and uniform protective film having high adhesion without damaging the heat-shrink film substrate and ink absorbing layer, without using a method involving large thermal load, such as extrusion molding. Furthermore, an inexpensive resin layer can be formed with a method having high productivity without using a radiation-curable material which is expensive and poses large load on apparatus.

The present invention is that the ink absorbing layer is swollen by the organic solvent in the step of applying a solution of a thermoplastic resin dissolved in an organic solvent to the print side.

The present invention is that a part of the ink absorbing layer is dissolved by the organic solvent in the step of applying a solution of a thermoplastic resin dissolved in an organic solvent to the print side.

The present invention is that the ink absorbing layer is impregnated with the thermoplastic resin in the step of applying a solution of a thermoplastic resin dissolved in an organic solvent to the print side.

The present inventors have found that a layered heat-shrink film having further high water resistance can be realized even in the case of using the same resin by using a solvent having a property that can swell the ink absorbing layer or can dissolve a part thereof, as an organic solvent used in forming the protective layer. This is considered from the experimental investigation results on swelling and solubility of resin to each solvent and water resistance of a layered film described hereinafter that when a solution of a thermoplastic resin constituting the protective layer dissolved in an organic solvent is applied to the print side and the ink absorbing layer is impregnated with the solution, the interface between the protective layer and the ink absorbing layer is in a fusion state, and as a result, a layered structure having high water resistance of the protective layer and the ink absorbing layer that are integrated is formed.

The present invention is that the protective layer and the ink absorbing layer are fused in the step of evaporating the organic solvent at a temperature lower than a temperature at which the substrate initiates to shrink, thereby forming a protective layer.

This surely performs swelling of the ink absorbing layer, partial dissolution of the ink absorbing layer and impregnation of the ink absorbing layer with the thermoplastic resin. As a result, it is possible to obtain a layered heat-shrink film having further fastness and excellent water resistance.

The present invention is that the coating composition used in the step of forming the ink absorbing layer having hydrophilicity contains A) a partially benzalated polyvinyl alcohol resin, B) a dicyandiamide type cationic resin, C) any one of additives of a spherical resin powder and a polyether-modified silicone.

This can realize good balance between the ink absorptive property and water resistance and high circularity of the print dot, and therefore can realize an ink absorbing layer having excellent blocking resistance.

The present invention is that the coating composition used in the step of applying a solution of a thermoplastic resin dissolved in an organic solvent to the print side contains A) an organic solvent that can swell the ink absorbing layer, B) a thermoplastic resin that can shrink along heat shrinkage of the film substrate and has a glass transition temperature lower than the heat shrinkage temperature of the film substrate, and C) any one of additives of a polysiloxane derivative, an atomized wax and a resin fine particle.

This can realize a layered heat-shrink film having particularly excellent fastness properties.

The container of the present invention is that the above-described layered heat-shrink film is fitted to the container in a shrunk state.

This can provide an excellent container that can prevent deterioration of the print side due to wetting, high humidity environmental shelf, and action of external force such as rubbing or bending.

The method for producing a container of the present invention comprises fitting the layered heat-shrink film to an outer surface of a container, heating the layered heat-shrink film at a temperature higher that the shrinkage initiation temperature of the substrate and the glass transition temperature of the thermoplastic resin, and heat shrinking the layered heat-shrink film.

This method makes it possible to perform plateless printing by a water-based ink-jet printing and to easily produce a container having excellent fastness properties, water resistance and the like.

1. A layered shrink film comprising:
a substrate having heat shrinkability,
an ink absorbing layer having hydrophilicity, and
a protective layer which shrinks along heat shrinkage of the substrate,
the ink absorbing layer being interposed between the substrate and the protective layer.

2. The layered shrink film as claimed in claim 1, wherein the protective layer comprises a thermoplastic resin having water resistance and scratch fastness.

3. The layered shrink film as claimed in claim 1, wherein the ink absorbing layer comprises a swelling type material containing a water-absorptive resin.

4. The layered shrink film as claimed in claim 1, wherein the protective layer contains an organic solvent which swells the ink absorbing layer.

5. The layered shrink film as claimed in claim 1, wherein the ink absorbing layer comprises a partially benzalated polyvinyl alcohol resin and a dicyandiamide type cationic resin.

6. The layered shrink film as claimed in claim 1, wherein
the protective layer comprises a thermoplastic resin which shrinks along heat shrinkage of the substrate and has water resistance and scratch resistance, and an organic solvent which swells the ink absorbing layer,
the ink absorbing layer is interposed between the substrate layer and the protective layer, and
at least a part of the protective layer impregnates in the ink absorbing layer.

7. The layered shrink film as claimed in claim 1, wherein the protective layer comprises a thermoplastic resin and has a glass transition temperature lower than a heat shrinkage temperature of the film substrate.

8. A method for producing a layered shrink film, which comprises:
a step of forming an ink absorbing layer having hydrophilicity on a substrate having heat shrinkability,
a step of forming a print image on the ink absorbing layer by a water-based ink-jet method,
a step of applying a solution of a thermoplastic resin dissolved in an organic solvent to the print side, and
a step of evaporating the organic solvent at a temperature lower than a temperature at which the substrate initiates to shrink, thereby forming a protective layer.

9. The method for producing a layered shrink film as claimed in claim 8, wherein the ink absorbing layer is swollen by the organic solvent in the step of applying a solution of a thermoplastic resin dissolved in an organic solvent to the print side.

10. The method for producing a layered shrink film as claimed in claim 8, wherein a part of the ink absorbing layer is dissolved by the organic solvent in the step of applying a solution of a thermoplastic resin dissolved in an organic solvent to the print side.

11. The method for producing a layered shrink film as claimed in claim 8, wherein the ink absorbing layer is impregnated with the thermoplastic resin in the step of applying a solution of a thermoplastic resin dissolved in an organic solvent to the print side.

12. The method for producing a layered shrink film as claimed in claim 8, wherein the protective layer and the ink absorbing layer are fused in the step of evaporating the organic solvent at a temperature lower than a temperature at which the substrate initiates to shrink, thereby forming a protective layer.

13. A container using the layered shrink film as claimed in claim 1, wherein the layered shrink film is fitted to the container in a shrunk state.

14. A container using the layered shrink film as claimed in claim 2, wherein the layered shrink film is fitted to the container in a shrunk state.

15. A container using the layered shrink film as claimed in claim 3, wherein the layered shrink film is fitted to the container in a shrunk state.

16. A container using the layered shrink film as claimed in claim 4, wherein the layered shrink film is fitted to the container in a shrunk state.

17. A container using the layered shrink film as claimed in claim 5, wherein the layered shrink film is fitted to the container in a shrunk state.

18. A container using the layered shrink film as claimed in claim 6, wherein the layered shrink film is fitted to the container in a shrunk state.
